(19) United States
(12) Patent Application Publication
(10) Pub. No.: US 2024/0339770 A1
(43) Pub. Date: Oct. 10, 2024

(54) Module Connector

(71) Applicant: Intercable Automotive Solutions GmbH, Bruneck (IT)

(72) Inventor: Christoph Baumgartner, Bruneck (IT)

(21) Appl. No.: 18/605,983

(22) Filed: Mar. 15, 2024

(30) Foreign Application Priority Data
Apr. 5, 2023 (EP) 23166794

(51) Int. Cl. H01R 4/70; H01M 50/503; H01R 4/34

(52) U.S. Cl. CPC H01R 4/70; H01M 50/503; H01R 4/34; H01M 2220/20; H01R 2201/26

(57) ABSTRACT

A module connector for batteries includes two connecting parts that can be electrically conductively connected to one another. The first connecting part has a first conductor element and a first contact element. The second connecting part has a second conductor element and a second contact element. The two connecting parts can be connected to one another via a common fastening element. When the two connecting parts are not connected to one another, an intermediate space is formed in the first connecting part between the fastening element and the first contact element. When the two connecting parts are not connected to one another, the fastening element is arranged in a park position and a separating element for electrically insulating the fastening element is arranged in the intermediate space between the fastening element and the first contact element and the first conductor element. The separating element has a sleeve shape.

### CROSS-REFERENCE TO RELATED APPLICATIONS

This application claims priority to EP 23 166 794 filed Apr. 5, 2023, the entire disclosure of which is incorporated by reference.

### FIELD

The present disclosure relates to relates to a module connector, in particular a module connector for batteries for a vehicle.

### BACKGROUND

Module connectors are generally known from the state of the art. Module connectors are used to connect individual modules that form a battery in a vehicle. Since such modules consist of current-carrying components, direct contact with these modules by people, such as a service employee in a workshop, can be dangerous, which is why appropriate contact protection must be provided in order to minimize the risk of live parts of the module connector being touched during maintenance or repair work on the vehicle.

EP 34 19 119 B1 describes a module connector of this type that counteracts this risk with appropriate contact protection. The transmission of currents between two conductors takes place via the module connector by means of a so-called current bridge, which is designed as a contact sleeve. This in turn consists of two current-carrying conductors that are connected to each other for electrical contacting. The contact protection ensures that live parts of the current bridge are not directly accessible to people. This is provided by a sleeve that surrounds the contacts and a fastening element, as well as by the fastening element, which has an electrically insulated cap at the tip.

One problem with module connectors with this type of contact protection, however, is that the electrical insulation of the electrically insulated cap of the fastening element increasingly deteriorates and/or can be damaged as the module connector is used, i.e. through repeated electrical contact and disconnection as well as mechanical coupling and decoupling of the two current-carrying parts of the module connector. As a result, a module connector provided in this way with this type of contact protection cannot reliably provide suitable contact protection. This described application scenario impairs the service life and functionality of the module connector and ultimately leads to increased maintenance requirements for the module connector with the associated additional costs.

In this context, it has now become apparent that there is a need to provide an improved module connector which, using simple means, minimizes the disadvantages of known module connectors and reliably guarantees the operational readiness and functionality of the module connector according to the present disclosure.

These and other tasks, which are still mentioned or can be recognized by the skilled person when reading the following description, are solved by the subject matter of the independent claims. The dependent claims further develop the central idea of the present disclosure in a particularly advantageous manner.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A module connector according to the present disclosure, in particular a module connector for batteries for a vehicle, having two connecting parts which can be connected to one another in an electrically conductive manner. The first connecting part has a first conductor element and a first contact element. The second connection part has a second conductor element and a second contact element. The two connection parts can be connected to one another via a common/joint fastening element, wherein, when the two connection parts are not connected to one another, an intermediate space is provided in the first connection part between the fastening element and the first contact element first conductor element and the fastening element is arranged in a park position. A separating element for electrically insulating the fastening element is arranged in the intermediate space between the fastening element and the first contact element and the first conductor element. The separating element has a sleeve shape. To establish an electrically conductive connection between the two connecting parts, the module connector is designed/configured to bring a contact surface of the first contact element of the first conductor element into direct contact with a contact surface of the second conductor element by changing the position of the fastening element from a first state, in which there is no electrically conductive connection between the two connecting parts, to a second, electrically conductive state of the two connecting parts. The first connection part has a first, outer contact-protection element and a first, inner contact-protection element, wherein the first, outer contact-protection element has an outer, electrically insulating protective sleeve which at least partially surrounds the first contact element and the fastening element, and wherein the first, inner contact-protection element is formed by the fastening element.

The basic idea of the present disclosure is therefore that by providing a separating element in the intermediate space between the fastening element and the first contact element of the first conductor element, suitable electrical insulation of the fastening element can be achieved in a parking position when the two connecting parts are not connected to each other. This makes it possible to dispense with additional insulating components on the fastening element that are susceptible to wear and damage. This makes it possible to provide a module connector that provides suitable contact protection even after multiple mating or contacting cycles between the two connecting elements of the module connector according to the present disclosure.

Due to the separating element in the intermediate space between the fastening element and the first contact element of the first conductor element, additional insulating components on the fastening element that are susceptible to wear and damage can be dispensed with, so that the module connector according to the present disclosure has improved functionality and an increased service life, which is also accompanied by reduced susceptibility to maintenance of the module connector.

In a further embodiment of the module connector according to the present disclosure, the module connector is designed to bring the fastening element into the park position when the fastening element is opened. This provides a simple touch protection function when the first connecting part and the second connecting part are not coupled to each other.

In a further embodiment of the module connector according to the present disclosure, the separating element is provided from a fiber-reinforced plastic. By providing the separating element with a fiber-reinforced plastic, additional reliable electrical insulation of the fastening element in front of the first contact element of the first conductor element can be provided. In addition, a durable and consistent electrical insulation can be provided by using a fiber-reinforced plastic.

In a further embodiment of the modular connector according to the present disclosure, the separating element is provided from a glass-fiber-reinforced thermosetting plastic. By providing the separating element with a glass-fiber-reinforced thermosetting plastic, additional reliable electrical insulation of the fastening element can be provided in front of the first contact element of the first conductor element. In addition, a durable and consistent electrical insulation can be provided by using a fiber-reinforced plastic.

In a further embodiment of the module connector according to the present disclosure, the first, inner contact-protection element is formed by the fastening element when the fastening element is in the park position. This achieves the advantage that a direct touching of all non-current-carrying or voltage-carrying components and current-carrying or voltage-carrying components of the module connector is prevented.

In a further embodiment of the module connector according to the present disclosure, the electrically insulating protective sleeve protrudes over the first contact element. In this way, suitable contact/touch protection of the first connecting element can be provided.

In a further embodiment of the modular connector according to the present disclosure, the first connecting part has a retaining element, wherein the retaining element is designed in such a way that the fastening element is arranged in the park position when the two connecting parts are not connected to one another. This comprises that the fastening element is held in the park position when the two connecting parts are not connected and/or returns to the park position after the two connecting parts of the module connector have been released from an end position. This can ensure that the fastening element is arranged in the park position and is thus electrically insulated from the first contact element of the first conductor element when the two connecting parts are not connected to each other.

In a further embodiment of the module connector according to the present disclosure, the first connecting part also has a first further contact-protection element, wherein the first further contact-protection element is formed by a cover element of the fastening element. This achieves the advantage that a direct touching of all non-current-carrying or voltage-carrying components and current-carrying or voltage-carrying components of the module connector is prevented.

In a further embodiment of the module connector according to the present disclosure, the cover element has a through-opening. This has the advantage that the fastening element can be actuated, but direct contact with current-carrying or live components of the module connector is prevented.

In a further embodiment of the modular connector according to the present disclosure, the cover element and the retaining element together form a one-piece element, and/or the one-piece element consisting of the cover element and the retaining element is rotatable about an axis of rotation of the fastening element. This simplifies the operation of the fastening element.

In a further embodiment of the modular connector according to the present disclosure, the fastening element is a screw with a head portion and a body portion, wherein the body portion is free of an electrically insulating material. By forming the fastening element as a screw, a simple and detachable connection of the first and second connecting parts of the module connector can be provided.

In a further embodiment of the module connector according to the present disclosure, the second connecting part further comprises a second outer contact-protection element, a second inner contact-protection element, a further contact-protection element and a counter element to the fastening element, wherein the second outer contact-protection element comprises an outer, electrically insulating protective sleeve which at least partially surrounds the second contact element and the second conductor element, the counter element and/or the contact surface of the second conductor element, wherein the second inner contact-protection element is arranged on the counter element. This achieves the advantage that the module connector, in particular the second connecting part, has a comprehensive and flexible protective function against unintentional contact with current-carrying or live components, regardless of the side or position from which the module connector is gripped.

In a further embodiment of the modular connector according to the present disclosure, the electrically insulating protective sleeve protrudes over the second contact element. In this way, suitable contact protection can be provided for the second connecting element.

In a further embodiment of the modular connector according to the present disclosure, the second inner contact-protection element is an electrically insulating protective sleeve. This has the advantage that the module connector, in particular the second connecting part, has an improved comprehensive and flexible protective function against unintentional contact with current-carrying or live components, irrespective of the side or position from which the module connector is gripped.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 shows a schematic sectional view of a first embodiment of a module connector according to the present disclosure in the non-connected state;

FIG. 2 shows a schematic sectional view of a first embodiment of a module connector according to the present disclosure in the connected state;

FIG. 3 shows a schematic sectional view of a first embodiment of a first connecting part according to the present disclosure;

FIG. 4 shows a schematic sectional view of a first embodiment of a second connecting part according to the present disclosure;

FIG. 5 shows a schematic sectional view of a second embodiment of a module connector according to the present disclosure in the non-connected state;

FIG. 6 shows is a schematic sectional view of a second embodiment of a module connector according to the present disclosure in the connected state;

FIG. 7 shows a schematic sectional view of a second embodiment of a first connecting part according to the present disclosure;

FIG. 8 shows an external view of a further example of a module connector in the connected state;

FIG. 9 shows a schematic sectional view of a further example of a second connecting part;

FIG. 10 shows a schematic sectional view of a further example of a module connector in the non-connected state;

FIG. 11 shows a schematic sectional view of a further example of a module connector in the connected state;

FIG. 12 shows a schematic sectional view of a further example of a module connector in the non-connected state;

FIG. 13 shows a schematic sectional view of a further example of a module connector in the connected state;

In the drawings, reference numbers may be reused to identify similar and/or identical elements.

### DETAILED DESCRIPTION

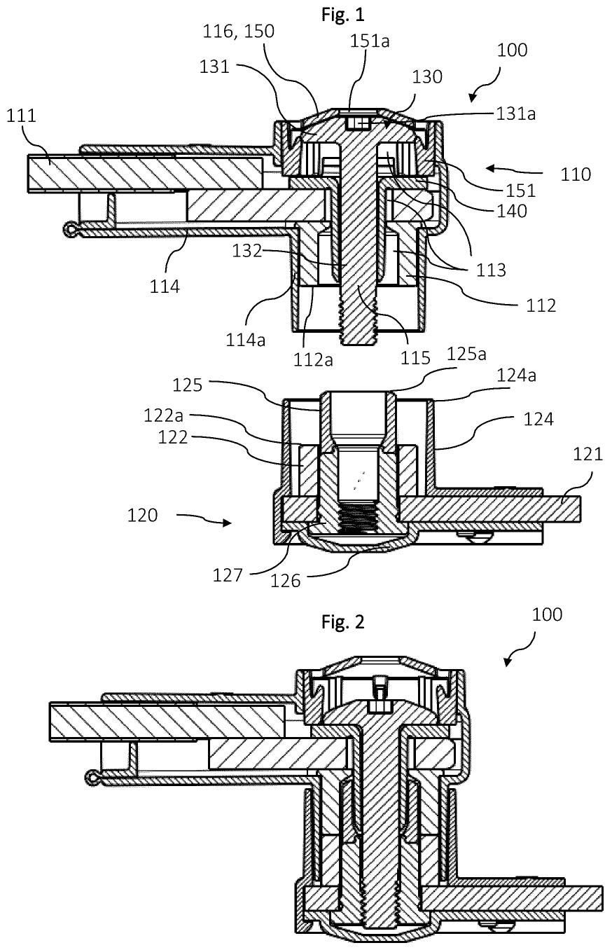

FIG. 1 shows a schematic sectional view of a first embodiment of a module connector 100 according to the present disclosure in a non-connected state. The module connector 100 has two connecting parts 110, 120, which can be electrically conductively and mechanically connected to one another. The first connecting part 110 has a first conductor element 111 and a first contact element 112. The first contact element 112 has a sleeve shape with a cylindrical recess. The second connecting part 120 has a second conductor element 121. The two conductor elements 111, 121 can each be designed as busbars. The two conductor elements 111, 121 are made of an electrically conductive material. For example, the two conductor elements 111, 121 can be made of copper or aluminum, but are not limited to this. The two conductor elements 111, 121 can be made of the same or a different electrically conductive material. The first conductor element 111 has an interface, in particular a through-hole or an elongated hole, through which the fastening element 130 is guided. An elongated/slotted hole can be used to provide tolerance compensation during assembly or when connecting the two connecting parts 110, 120. The second conductor element 121 also has an interface, in particular a through-hole, in which a mating/counter element 127 to the fastening element 130 is arranged. Here, the interface or the through-hole can have a diameter which essentially corresponds to that of the mating/counter element 127, so that the counter element 127 is in contact with the interface, in particular the through-hole, in particular with the entire interface. The counter element 127 can be made of the same or a different material as the second conductor element 121. In this way, a suitable and reliable mechanical connection can be provided between the first connecting part 110 and the second connecting part 120.

The first conductor element 111 is at least partially or in sections electrically insulated by a first outer contact-protection element 114 surrounding it. The first outer contact-protection element 114 can be formed in one or more parts and is made of or is provided from an electrically insulating material, in particular an electrically insulating plastic. The first outer contact-protection element 114 has a recess in which a retaining element 151 of the fastening element 130 is arranged. The retaining element 151 of the fastening element 130, together with a cover element 150 of the fastening element 130, forms a first further contact-protection element 116. Therein, the cover element 150 and the retaining element 151 together form a one-piece element. The cover element 150 has a through-opening 151a through which a tool can reach the fastening element 130. The one-piece element consisting of the cover element 150 and the retaining element 151 can be arranged to rotate about an axis of rotation of the fastening element 130 in order to facilitate actuation of the fastening element 130. The covering element 150 or the first further contact-protection element 116 has the function of shielding or separating the current-carrying and voltage-carrying parts inside the module connector 100 from a direct touching/contact from the outside. The cover element 150 or the first further contact-protection element 116 additionally has the function that the fastening element 130 can be driven by means of the through-opening 151a of the cover element 150 of the first connecting part 110 of the module connector 100, for example with the aid of a tool not shown here, in order to bring the fastening element 130 from a parked position into a corresponding end position, so that an electrically conductive connection can be established between the two conductor elements 111, 121 of the connecting parts 110, 120 of the module connector. The fastening element 130 is held in the parked position by the retaining element 151.

The two connecting parts 110, 120 can be connected to one another via a common fastening element 130. The first connecting part 110 and the second connecting part 120 are designed/configured in such a way that they interlock, i.e. that these two parts 110, 120 can be pushed into one another. In detail, the first connecting part 110 can be pushed into the second connecting part 120 so that slippage of the two connecting parts 110, 120 can be reliably prevented. In the illustrated embodiment according to the present disclosure, the fastening element 130 is designed as a screw or a bolt made of metal. The fastening element 130 has a head portion 131 and a body portion 132. The fastening element 130 is to be regarded as a current-carrying or voltage-carrying part of the module connector 100, which must be shielded from direct contact. This function is performed by a separating element 140 arranged in an intermediate space 113, as will be explained in more detail below

FIG. 1 shows that the intermediate space 113 between the fastening element 130 and the first contact element 112 as well as the first conductor element 111 is provided in such a way that both the head portion 131 and the body portion 132 of the fastening element 130 are not in contact, in particular in direct contact, and/or in electrical connection with the live elements 112 and 111. The intermediate space 113 is provided in that the interface, in particular the through-hole or elongated hole, of the first conductor element 111 and the cylindrical recess of the first contact element 112 each have a larger diameter than the fastening element 130, in particular the body portion 132. The diameter of the interface and the diameter of the cylindrical recess of the first contact element 112 can be identical or different. In this case, the diameters of the fastening element 130, in particular the body portion, the interface and the cylindrical recess are designed in such a way that the fastening element 130, in particular the body portion 132, is spaced apart from the interface and the first contact element. In addition, the separating element 140 is arranged between the fastening element 130, the first conductor element 111 and the first contact element 112, whereby suitable electrical insulation of the fastening element is provided. The fastening element 130 extends through a passage opening in the separating element 140 or is guided by the separating element 140. The separating element 140 is made of a fiber-reinforced plastic, in particular a glass-fiber-reinforced thermosetting plastic. The material used here has the advantage that, on the one hand, it is very stable and can compensate for strong forces that can occur when the two connecting parts 110, 120 are screwed together and, on the other hand, it is electrically insulating. The separating element 140 is designed as a sleeve, which has two parts. The first part extends parallel to the body portion 132 of the fastening element 130. The second part extends perpendicular to the body portion 132 of the fastening element 130. The first part of the separating element 140 provides electrical insulation of the body portion 132 of the fastening element 130 from the conductor element 111 and the first contact element 112, and the second part provides electrical insulation of the head portion 131 of the fastening element 130 from the conductor element 111.

As already described above, the fastening element 130 is held or arranged in the parking position by means of the retaining element 151. Here, the head portion 131 of the fastening element 130 is in contact with the cover element 150. In other words, the retaining element 151 presses the head portion 131 of the fastening element 130 against the cover element 150. The retaining element 151 and/or the cover element 150 are made of plastic. As a result, the fastening element 130 is only in contact with non-electrically conductor elements in the parking position, in particular in direct contact or touch contact. Thus, unintentional movement of the fastening element 130 when it is in the parking position can be prevented. Unintentional electrical contact of the fastening element 130 with the first conductor element 111 and/or the first contact element 112 is thus reliably prevented by the separating element 140. Furthermore, in this way the fastening element 130 can provide protection against contact within the first connecting part 110, although the fastening element 130 is made of metal, for example. In other words, the fastening element 130 thus constitutes a first inner contact-protection element 115 of the first connecting part 110. The retaining element 150 can thereby comprise several retaining elements with a snap-on function.

The first outer contact-protection element 114 has an outer, electrically insulating protective sleeve 114a. The protective sleeve 114a at least partially surrounds the first contact element 112 and the fastening element 130. The protective sleeve 114a is arranged directly on a first surface of the first contact element 112, wherein the first surface of the first contact element 112 is opposite to a second surface of the first contact element 112 facing the fastening element 130. The electrically insulating protective sleeve 114a extends or covers at least partially or completely the first surface of the contact element 112. In particular, the electrically insulating protective sleeve 114a protrudes beyond the first surface of the first contact element 112. However, the electrically insulating protective sleeve 114a is formed such that the contact surface 112a of the contact element 112 is not covered, that is, is exposed. Consequently, the contact surface 112a of the contact element 112 does not protrude beyond the electrically insulating protective sleeve 114a. In other words, the contact surface 112a of the contact element 112 does not tower over the electrically insulating protective sleeve 114a.

The fastening element 130 can be moved from a park position, in which there is no electrically conductive connection between the two conductor elements 111, 121 of the two connecting parts 110, 120 of the module connector 100, to an end position. In the end position, the fastening element 130 is fixed with a nut or a press-in nut. The nut or the press-in nut is formed by the counter element 127, which is designed as a threaded bushing and with which the body portion 132 of the fastening element 130 is fixed in the end position of the fastening element 130. The fixation can be designed as a screw connection, latching, clipping or press-fit or, generally speaking, as any form-locking or force-locking connection between the fastening element 130 and the counter element 127.

When the fastening element 130 is released, the fastening element 130 is moved from its end position to a parking position. This is provided by the retaining element 151. In the process, the fastening element 130 is unscrewed from the counter element 127, which is designed as a threaded bushing, if the fastening element 130 is designed as a screw.

In the parked position—as shown in FIG. 1—of the fastening element 130, the contact surface 112a of the first contact element 112 and the contact surface 121a of the second conductor element 121 do not lie on top of one another, so that in this first state there is no electrically conductive connection between the first conductor element 111 of the first connecting part 110 and the second conductor element 121 of the second connecting part 120.

FIG. 1 further shows that the second connecting part 120 has a second, outer contact-protection element 124, a second, inner contact-protection element 125 and a second further contact-protection element 126. The second, inner contact-protection element 125 is designed as an insulating spacer bushing or as an insulating protective sleeve.

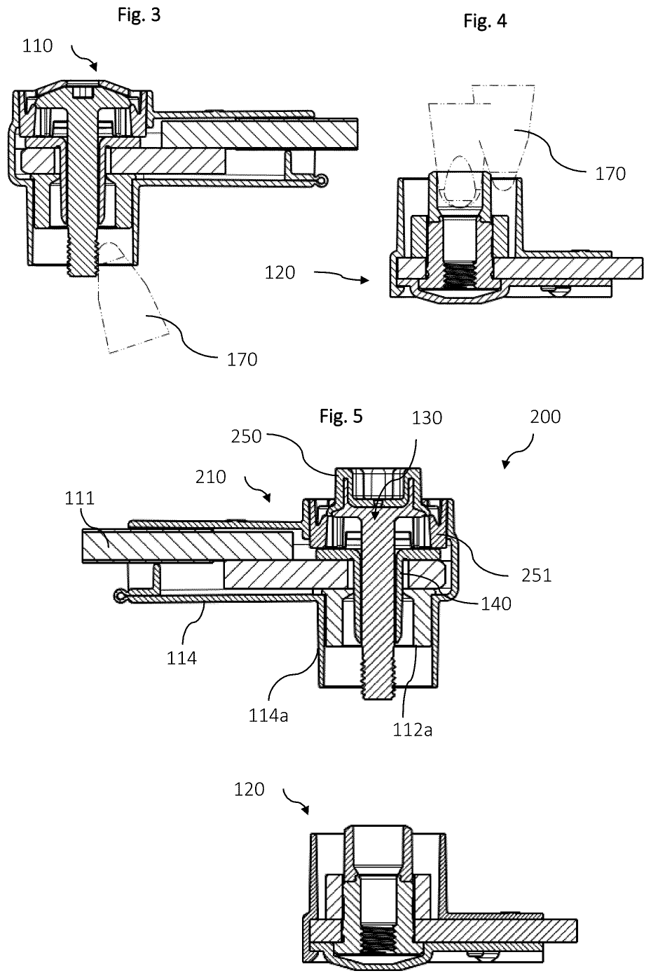

In FIG. 1 it can be seen that the second, inner contact-protection element 125 of the second connecting part 120 is formed, arranged in a space between the second, outer contact-protection element 124 of the second connecting part 120 and the fastening element 130. The second, inner contact-protection element 125 thereby extends out of an opening provided by the second, outer contact-protection element 124. In other words, the second, inner contact-protection element 125 protrudes with respect to the second, outer contact-protection element 124 or the second, inner contact-protection element 125 protrudes beyond the second, outer contact-protection element 124. Thus, a suitable touch protection can be provided. Accordingly, as shown in FIG. 3, a test finger 170 can reach non-current-carrying elements of the first connection portion 110, resulting in a desired complete touch protection.

The aforementioned contact-protection elements 124, 125, 126 of the second connecting part 120 consist of an electrically insulating material and prevent unintentional contact with current-carrying and live parts of the second connecting part 120. This is also clearly illustrated in FIG. 4 by the standardized test fingers 170, which cannot touch current-carrying and live parts of the second connecting part 120 of the module connector 100 due to the aforementioned contact-protection elements.

The first connecting part 110 and the second connecting part 120 are configured in such a way that they interlock, i.e. that these two parts 110, 120 can be pushed into one another. In detail, the first connecting part 110 can be pushed into the second connecting part 120 so that slippage of the two connecting parts can be reliably prevented.

The first embodiment of the module user 100 according to the present disclosure is thus completely protected against contact in the non-connected state. The second connecting element 120 is designed to be protected against contact, since a standardized test finger 170 does not come into contact with the first conductor element (see FIG. 4). The first connecting element 110 is also completely contact-protected, since a standardized test finger 170 can touch the first contact element 112.

FIG. 2 shows a schematic sectional view of a first embodiment of a module connector 100 according to the present disclosure in the connected state or in a second operating state. In the connected state, the fastening element 130 is arranged in the end position of the fastening element 130 and the contact surface 112a of the first contact element 112 and the contact surface 122a of the second contact element 122 are in direct contact for providing an electrical connection between the first connection part 110 and the second connection part 120.

In the end position, the fastening element 130, i.e. a screw, is arranged in a threaded bushing, which forms the counter element 127, with which the body portion 132 of the fastening element 130 is fixed in the end position of the fastening element 130. The fixing is a screw connection and forms a form-fit or force-fit connection between the fastening element 130 and the counter element 127. In the end position of the fastening element 130, the fastening element 130, in particular the body portion 132 of the fastening element 130, is rotated deeply into the counter element 127 such that the head portion 131 of the fastening element 130 is adjacent to or in direct contact with the first conductor element 111. Thus, a suitable and reliable fastening of the first connecting part 110 or the first further element 111 and the second connecting part 120 or second conductor element 121 can be provided.

Furthermore, when the fastening element 130 is in the end position or the module connector 100 is in the connected state, the contact surface 112a of the first contact element 112 and the contact surface 122a of the second contact element 122 of the second conductor element 121 are directly on top of each other, so that in this second state there is an electrically conductive connection between the first conductor element 111 of the first connection part 110 and the second conductor element 121 of the second connection part 120. The contact surfaces 112a and 122a should have the largest possible surface area in order to keep the contact resistance between the two contact surfaces 112a and 122a as low as possible.

By interlocking the second connection part 120, which is protected against contact, and the first connection part 110, which is completely protected against contact, a completely contact-protected module connector 100 is provided in the connected state, since only completely contact-protected parts of the module connector can be touched by a user (see FIG. 2).

FIG. 3 shows a schematic sectional view of a first embodiment of a first connecting part 110 according to the present disclosure. FIG. 3 shows that the first connecting part 110 is designed to be protected against contact, since none of the current-carrying elements of the first connecting part 110 can be reached by a test finger 170.

FIG. 4 shows a schematic sectional view of a first embodiment of a second connecting part 120 according to the present disclosure. FIG. 4 shows that the second connecting part 120 is designed to be protected against contact, since none of the current-carrying elements of the second connecting part 120 can be reached by a test finger 170.

FIG. 5 shows a schematic sectional view of a second embodiment of a module connector 200 according to the present disclosure in the non-connected state. The module connector 200 differs from the first embodiment of the module connector 100 according to the present disclosure shown in FIGS. 1 to 4 in that the retaining element 251 and the cover element 250 are not formed in one piece, i.e. as two separate parts. The retaining element 251 holds the fastening element 130 in the park position. The cover element 250 is formed as an electrically insulating enclosure of the head portion 131 of the fastening element 130. In other words, the second embodiment of the module connector 200 according to the present disclosure differs from the first embodiment of the module connector 100 according to the present disclosure in that only the first connecting part 210 is different. Here, both connecting parts are each designed to be protected against contact.

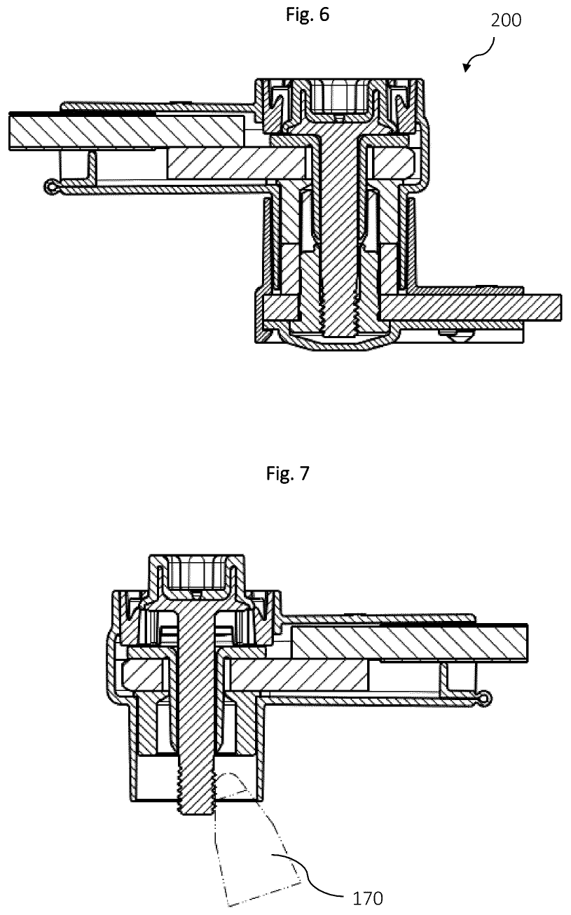

FIG. 6 shows a schematic sectional view of a second embodiment of a module connector 200 according to the present disclosure in the connected state. In this state, the first connecting part 210 and the second connecting part 120 are mechanically connected to one another via the fastening element. In addition, direct contacting of the first contact element 112 with the second contact element 122 provides electrical contacting of the first connecting part 210 and the second connecting part 120.

FIG. 7 shows a schematic sectional view of a second embodiment of a first connecting part 210 according to the present disclosure. It can be seen from FIG. 7 that the second embodiment of the first connecting part 210 according to the present disclosure is also completely protected against contact, since a test specimen 170 cannot touch any of the current-carrying elements.

FIG. 8 shows a schematic sectional view of a further example of a module connector 300 in a non-connected state. The module connector 300 has two connecting parts 310, 320, which can be electrically conductively and mechanically connected to one another. The first connection part 310 has a first conductor element 311 and a first contact element 312. The first contact element 312 has a sleeve shape with a cylindrical recess. The second connecting part 320 has a second conductor element 321. The two conductor elements 311, 321 can each be designed as busbars. The two conductor elements 311, 321 are made of an electrically conductive material. For example, the two conductor elements 311, 321 can be made of copper or aluminum, but are not limited to this. The two conductor elements 311, 321 can be made of the same or a different electrically conductive material. The first conductor element 311 has an interface, in particular a through-hole or an elongated hole, through which the fastening element 330 is guided. An elongated/slotted hole can be used to provide tolerance compensation during assembly or when connecting the two connecting parts 310, 320. The second conductor element 321 also has an interface, in particular a through-hole, in which a counter element 327 to the fastening element 330 is arranged. Here, the interface or the through-hole can have a diameter which essentially corresponds to that of the counter element 327, so that the counter element 327 is in contact with the interface, in particular the through-hole, in particular with the entire interface. The counter element 327 may be formed from the same or a different material as the second conductor element 321. Thus, a suitable and reliable mechanical connection can be provided between the first connection part 310 and the second connection part 320.

The first conductor element 311 is at least partially or in sections electrically insulated by a first outer contact-protection element 314 surrounding it. The first outer contact-protection element 314 can be formed in one or more parts and consists of or is provided from an electrically insulating material, in particular an electrically insulating plastic. The first outer contact-protection element 314 has a recess 314b, in which a retaining element 351 of the fastening element 330 is arranged. The retaining element 351 of the fastening element 330, together with a cover element 350 of the fastening element 330, forms a first further contact-protection element 316. Hereby, the cover element 350 and the retaining element 351 together form a one-piece element. The cover element 350 has a through-opening 351a through which a tool can reach the fastening element 330. The one-piece element consisting of the cover element 350 and the retaining element 351 can be arranged to rotate about an axis of rotation of the fastening element 330 in order to facilitate actuation of the fastening element 330. The covering element 350 or the first further contact-protection element 316 has the function of shielding or separating the current-carrying and voltage-carrying parts inside the module connector 300 from a direct touching from the outside. The cover element 350 or the first further contact-protection element 316 has the additional function that the fastening element 330 can be driven by means of the through-opening 351a of the cover element 350 of the first connecting part 310 of the module connector 300, for example with the aid of a tool not shown here, in order to bring the fastening element 330 from a parked position into a corresponding end position, so that an electrically conductive connection can be established between the two conductor elements 311, 321 of the connecting parts 310, 320 of the module connector. The fastening element 330 is held in the parked position by the retaining element 351.

The two connecting parts 310, 320 can be connected to each other via a common fastening element 330. The first connecting part 310 and the second connecting part 320 are designed in such a way that they interlock, i.e. that these two parts 310, 320 can be pushed into one another. In detail, the first connecting part 310 can be pushed into the second connecting part 320 so that slippage of the two connecting parts 310, 320 can be reliably prevented. In the example, the fastening element 330 is designed as a screw or a bolt made of metal. The fastening element 330 has a head portion 331 and a body portion 332. The fastening element 330 is to be regarded as a current-carrying or live part of the module connector 300, which must be shielded from direct contact/touch. This function is performed solely by an intermediate space 313, as will be explained in more detail below.

FIG. 8 shows that the intermediate space 313 alone provides the electrical insulation of the fastening element 330. The intermediate space 313 is provided here between the fastening element 330 and the first contact element 312 and the first conductor element 311 in such a way that both the head portion 331 and the body portion 332 of the fastening element 330 are not in contact, in particular in direct contact, and/or in electrical connection with the voltage-carrying elements 312 and 311. The intermediate space 313 is provided in that the interface, in particular the through-hole or elongated hole, of the first conductor element 311 and the cylindrical recess of the first contact element 312 each have a larger diameter than the fastening element 330, in particular the body portion 332. The diameter of the interface and the diameter of the cylindrical recess of the first contact element 312 can be identical or different. In this case, the diameters of the fastening element 330, in particular the body portion, the interface and the cylindrical recess are designed in such a way that the fastening element 330, in particular the body portion 332, is spaced apart from the interface and the first contact element. At this point, alone means that the intermediate space is free of any elements, in particular mechanical elements and means. When the two connecting parts 310, 320 are not connected to each other, the intermediate space 313 is provided here by arranging the fastening element 330 in the parking position.

As already described above, the fastening element 330 is held or arranged in the parking position by means of the retaining element 351. Here, the head portion 331 of the fastening element 330 is in contact with the cover element 350. In other words, the retaining element 351 presses the head portion 331 of the fastening element 330 against the cover element 350. The retaining element 351 and/or the cover element 350 are made of plastic. As a result, in the parking position the fastening element 330 is only in contact with electrically non-conducting elements, in particular in direct contact or touch contact. Thus, unintentional movement of the fastening element 330 when it is in the parking position can be prevented and unintentional electrical contact of the fastening element 330 with the first conductor element 311 and/or the first contact element 312 can be reliably prevented. Furthermore, in this way, the fastening element 330 can provide protection against contact within the first connection part 310, even though the fastening element 330 is made of metal, for example. In other words, the fastening element 330 thus constitutes a first inner contact-protection element 315 of the first connecting part 310. The retaining element 315 may thereby comprise a plurality of retaining elements with a snap-on function.

The first outer contact-protection element 314 has an outer, electrically insulating protective sleeve 314a. The protective sleeve 314a at least partially surrounds the first contact element 312 and the fastening element 330. The protective sleeve 314a is arranged directly on a first surface of the first contact element 312, wherein the first surface of the first contact element 312 is opposite to a second surface of the first contact element 312 facing the fastening element 330. The electrically insulating protective sleeve 314a extends or covers at least partially or completely the first surface of the contact element 312. Accordingly, the electrically insulating protective sleeve 314a does not protrude beyond the first surface of the first contact element 312. Here, however, the electrically insulating protective sleeve 314a is formed such that the contact surface 312a of the contact element 312 is not covered, that is, is exposed. Consequently, the contact surface 312a of the contact element 312 protrudes beyond the electrically insulating protective sleeve 314a. In other words, the contact surface 312a of the contact element 312 towers over the electrically insulating protective sleeve 314a.

The fastening element 330 can be moved from a park position, in which there is no electrically conductive connection between the two conductor elements 311, 321 of the two connecting parts 310, 320 of the module connector 300, to an end position. In the end position, the fastening element 330 is fixed with a nut or a press-in nut. The nut or the press-in nut is formed by the counter element 327, which is designed as a threaded bushing and with which the body portion 332 of the fastening element 330 is fixed in the end position of the fastening element 330. The fixation can be formed as a screw connection, latching, clipping or press-fit or, generally speaking, as any form of positive or non-positive connection between the fastening element 130 and the counter element 127.

When the fastening element 330 is released, the fastening element 330 is moved from its end position to a parking position. This is provided by the retaining element 351. In the process, the fastening element 330 is unscrewed from the counter element 327, which is designed as a threaded bush, if the fastening element 330 is designed as a screw.

In the parked position—as shown in FIG. 8—of the fastening element 330, the contact surface 312a of the first contact element 312 and the contact surface 321a of the second conductor element 321 do not lie on top of each other, so that in this first state there is no electrically conductive connection between the first conductor element 311 of the first connection part 310 and the second conductor element 321 of the second connection part 320.

FIG. 8 further shows that the second connecting part 320 has a second, outer contact-protection element 324, a second, inner contact-protection element 325 and a second, further contact-protection element 326. The second, inner contact-protection element 325 is designed as an insulating spacer bushing or as an insulating protective sleeve.

In FIG. 8, it can be seen that the second, inner contact-protection element 325 of the second connecting part 320 is formed in a space between the second, outer contact-protection element 324 of the second connecting part 320 and the fastening element 330. The second, inner contact-protection element 325 thereby extends out of an opening provided by the second, outer contact-protection element 324. In other words, the second, inner contact-protection element 325 protrudes with respect to the second, outer contact-protection element 324 or the second, inner contact-protection element 325 protrudes beyond the second, outer contact-protection element 324. Thus, a suitable touch protection can be provided.

The aforementioned contact-protection elements 324, 325, 326 of the second connecting part 320 consist of an electrically insulating material and prevent unintentional contact with live parts of the second connecting part 320. This is also clearly illustrated in FIG. 11 by the standardized test fingers 170, which cannot touch live parts of the second connecting part 320 of the module connector 300 due to the aforementioned contact-protection elements.

The example of the module user 300 is thus at least partially protected against contact in the non-connected state. The second connecting element 320 is designed to be protected against contact, since a standardized test finger 170 does not come into contact with the first conductor element (see FIG. 11). The first connecting element 310 is not completely protected against contact, since a standardized test finger 170 can touch the first contact element 312.

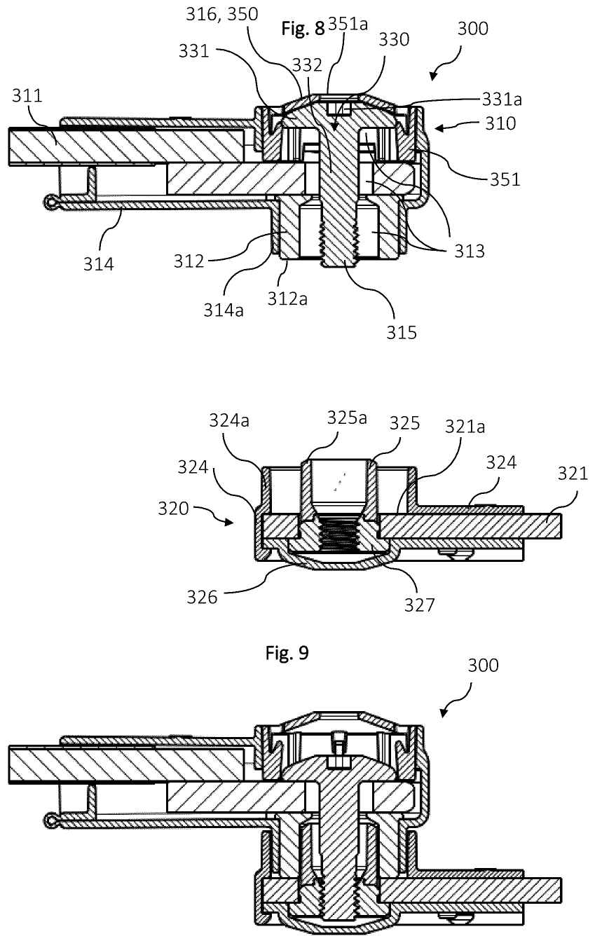

FIG. 9 shows a schematic sectional view of a further example of a module connector 300 in the connected state or in a second operating state. In the connected state, the fastening element 330 is arranged in the end position of the fastening element 330 and the contact surfaces 312a and 321a are in direct contact for providing an electrical connection between the first connection part 310 and the second connection part 320.

In the end position, the fastening element 330, i.e. a screw, is arranged in a threaded bushing, which forms the counter element 327, with which the body portion 332 of the fastening element 330 is fixed in the end position of the fastening element 330. The fixing is a screw connection and forms a positive or non-positive connection between the fastening element 330 and the counter element 327. In the end position of the fastening element 330, the fastening element 330, in particular the body portion 332 of the fastening element 330, is rotated deeply into the counter element 327 in such a way that the head portion 331 of the fastening element 330 is adjacent to or in direct contact with the first conductor element 311. Thus, a suitable and reliable fastening of the first connecting part 310 or the first further element 311 and the second connecting part 320 or second conductor element 321 can be provided. In addition, in the end position of the fastening element 330, the fastening element 330 can also serve as an electrical conductor between the first connecting element and the second connecting element 320.

Furthermore, when the fastening element 330 is in the end position or the module connector 300 is in the connected state, the contact surface 312a of the first contact element 312 and the contact surface 321a of the second conductor element 321 are directly on top of each other, so that in this second state there is an electrically conductive connection between the first conductor element 311 of the first connection part 310 and the second conductor element 321 of the second connection part 320. The contact surfaces 312a and 321a should have the largest possible surface area in order to keep the contact resistance between the two contact surfaces 312a and 321a as low as possible.

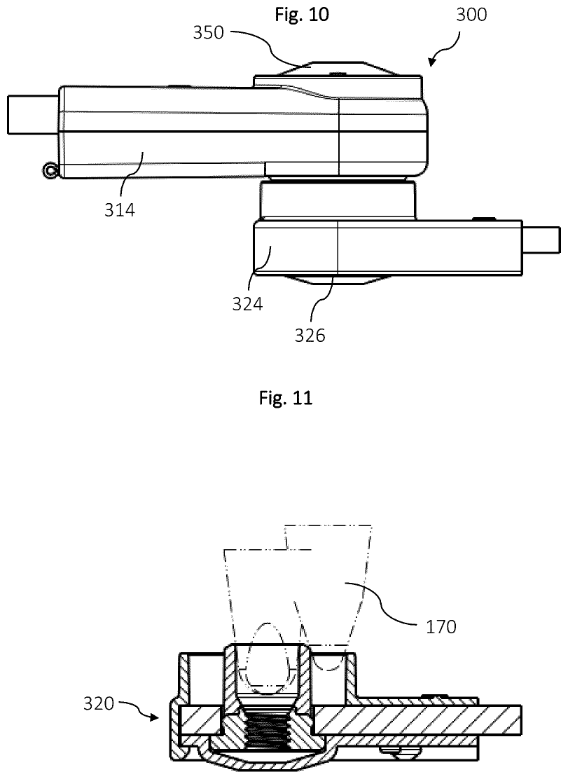

By interlocking the second connection part 320, which is protected against contact, and the first connection part 310, which is not fully protected against contact, a fully contact-protected module connector 300 is provided in the connected state, since only fully contact-protected parts of the module connector can be touched by a user (see FIG. 10).

FIG. 10 shows an external view of a further example of a module connector 300 in a connected state. The module connector 300 has a first outer contact-protection element 314, a second outer contact-protection element 324, a second further contact-protection element 326, and a cover element 350, with which suitable touch protection can be provided by the electrically conductive components or elements of the module connector 300. In this case, the first outer contact-protection element 314 is formed in two parts, i.e. with an upper side and a lower side, wherein the cover element 350 is arranged in the upper side.

FIG. 11 shows a schematic sectional view of a further example of a second connecting part 320. The second connecting part 320 is designed to be protected against contact, since none of the test fingers 170 reaches or can reach a current-conducting element of the second connecting part 320.

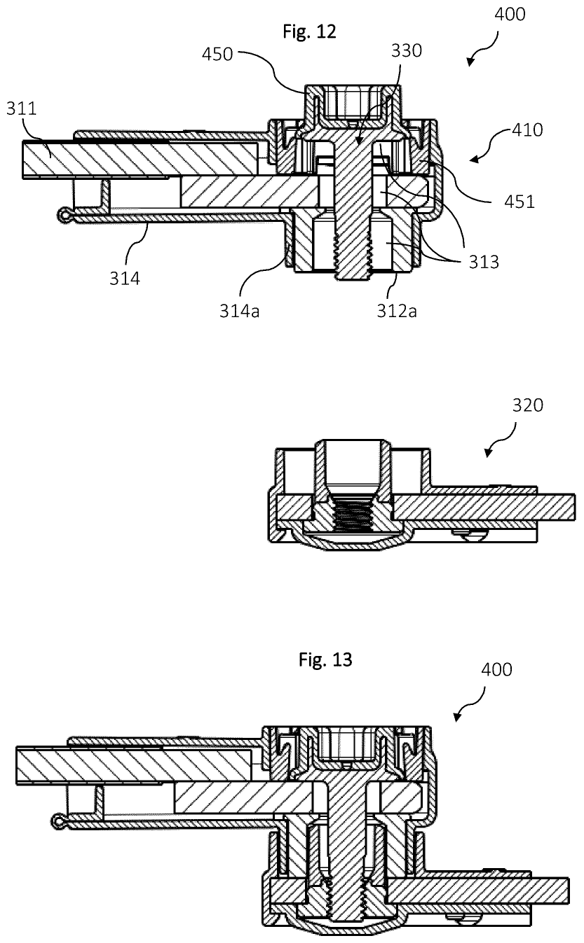

FIG. 12 shows a schematic sectional view of a further example of a module connector 400 in the non-connected state. The module connector 400 differs from the example of the module connector 300 from FIGS. 8 to 11 in that the retaining element 451 and the cover element 450 are not formed in one piece, i.e. as two separate parts. The retaining element 451 holds the fastening element 330 in the park position. The cover element 450 is designed as an electrically insulating sheathing of the head portion 331 of the fastening element 330. The sheathing is attached or provided directly to the head portion 331 of the fastening element 330. Thus, an alternative contact protection of the head portion 331 of the fastener 330 can be provided. In other words, the example of the module connector 300 differs from the example of the module connector 400 in that only the first connecting portion 410 is different.

FIG. 13 shows a schematic sectional view of a further example of a module connector 400 in the connected state. Here, the example also comprises a partially contact-protected first connection part 410 and a fully contact-protected second connection part 320, which in the connected state provide a fully contact-protected module connector 400.

The modular connector according to the present disclosure can be provided in the form of a modular system, so that the modular connector can be created and assembled variably and as desired or required. This provides additional flexibility in the application of the module connector,

However, the present invention disclosure is not limited to the preceding preferred embodiments as long as it is encompassed by the subject matter of the following claims. Additionally, it is noted that the terms “comprising” and “having” do not exclude other elements and the indefinite articles “one” or “a” do not exclude a plurality. Furthermore, it is noted that features or steps described with reference to any of the above embodiments may also be used in combination with other features of other embodiments described above.

The term non-transitory computer-readable medium does not encompass transitory electrical or electromagnetic signals propagating through a medium (such as on a carrier wave). Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The term “set” generally means a grouping of one or more elements. The elements of a set do not necessarily need to have any characteristics in common or otherwise belong together. The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

1. A module connector for batteries for a vehicle, the module connector comprising:
a first connecting part including a first conductor element and a first contact element; and
a second connecting part configured to be connected to the first connecting part in an electrically conductive manner via a fastening element, the second connecting part including a second conductor element and a second contact element,
wherein, when the first connecting part is not connected to the second connecting part, an intermediate space is provided in the first connecting part between the fastening element and the first contact element and the first conductor element and the fastening element is arranged in a parking position,
wherein a separating element for electrically insulating the fastening element is arranged in the intermediate space between the fastening element and the first contact element and the first conductor element,
wherein the separating element has a sleeve shape,
wherein, in order to establish an electrically conductive connection between the first connecting part and the second connecting part, the module connector is configured, by changing the position of the fastening element from a first state, in which there is no electrically conductive connection between the first connecting part and the second connecting part, to a second, electrically conductive state of the first connecting part and the second connecting part, to bring a contact surface of the first contact element of the first conductor element into direct contact with a contact surface of the second conductor element,
wherein the first connecting part includes a first, outer contact-protection element and a first, inner contact-protection element,
wherein the first, outer contact-protection element includes an outer, electrically insulating protective sleeve that at least partially surrounds the first contact element and the fastening element, and
wherein the first, inner contact-protection element is formed by the fastening element.

2. The module connector of claim 1 wherein the module connector is configured to bring the fastening element into the parking position when the fastening element is opened.

3. The module connector of claim 1 wherein the separating element is provided from a glass-fiber-reinforced thermosetting plastic.

4. The module connector of claim 3 wherein the separating element is provided from a glass-fiber-reinforced thermosetting plastic.

5. The module connector of any of claim 1 wherein the first, inner contact-protection element is formed by the fastening element when the fastening element is in the parking position.

6. The module connector of claim 1 wherein the electrically insulating protective sleeve projects beyond the first contact element.

7. The module connector of claim 1 wherein the first connecting part includes a retaining element designed such that the fastening element is arranged in the parking position when the first connecting part and the second connecting part are not connected to one another.

8. The module connector of claim 1 wherein the first connecting part includes a first further contact-protection element formed by a cover element of the fastening element.

9. The module connector of claim 8 wherein the cover element has a through-opening.

10. The module connector of claim 8 wherein the first connecting part includes a retaining element designed such that the fastening element is arranged in the parking position when the first connecting part and the second connecting part are not connected to one another, and wherein at least one of:
the cover element and the retaining element together form a one-piece element, or
the one-piece element consisting of the cover element and the retaining element is rotatable about an axis of rotation of the fastening element.

11. The module connector of claim 1 wherein:
the fastening element is a screw having a head portion and a body portion, and
the body portion is free of an electrically insulating material.

12. The module connector of claim 1 wherein:
the second connecting part includes a second outer contact-protection element, a second inner contact-protection element, a further contact-protection element and a counter element to the fastening element,
the second outer contact-protection element has an outer, electrically insulating protective sleeve that at least partially surrounds the second contact element and the second conductor element, the counter element and/or the contact surface of the second conductor element, and
the second inner contact-protection element is arranged on the counter element.

13. The module connector of claim 1 wherein the electrically insulating protective sleeve projects beyond the second contact element.

14. The module connector of claim 12 wherein the second inner contact-protection element is an electrically insulating protective sleeve.
